(19) United States
(12) Patent Application Publication
(10) Pub. No.: US 2005/0246281 A1
(43) Pub. Date: Nov. 3, 2005

(54) Rights information providing system, method and computer program fro realizing the same

(75) Inventors: Masahiro Gakuhari, Chiyoda-ku (JP); Osamu Uchida, Chiyoda-ku (JP); Noboru Ishimatsu, Chiyoda-ku (JP); Syunsuke Katsumata, Chiyoda-ku (JP)

Correspondence Address: George A. Loud;Lorusso Loud & Kelly, 3137 Mount Vernon Avenue, Alexandria, VA, 22305, US

(73) Assignee: HARRIS COMMUNICATIONS AUSTRIA GMBH

(21) Appl. No.: 10/500,011

(22) PCT Filed: Dec. 25, 2002
(86) PCT No.: PCT/JP02/13533

§ 371 Date: Mar. 21, 2005

(30) Foreign Application Priority Data
Dec. 27, 2001 (JP) 2001-396760

(51) Int. Cl. H04K 1/00; H04L 9/00; G06F 17/60

(52) U.S. Cl. 705/52

(57) ABSTRACT

Electronic tickets, electronic coupons, or the like are issued to customers who visit stores selling merchandise or event halls, thereby enlarging the customer base, improving the pulling power of the event hall, promoting the sale of merchandise, etc. A system for providing rights information includes a management server with a for storing a plurality of electronic tickets or coupons. The management server receives information on a customer from an in-store terminal, searches for an electronic ticket or coupon based on the customer information, and issues the electronic ticket or coupon to the customer.

### CROSS-REFERENCE TO RELATED APPLICATIONS

This application is a National Phase Application (35 USC 371) of PCT/JP02/13533 and claims priority of Japanese Application No. 2001-396760, filed Dec. 27, 2001.

### TECHNICAL FIELD

The present invention relates to a system for providing an electronic ticket or an electronic coupon to a consumer, and to a computer program therefor.

### BACKGROUND ART

In recent years, electronic tickets have been used as admission tickets in electronic form for concerts, movies, and the like. Also, electronic coupons have been used in electronic form in various stores. Such electronic tickets and coupons are utilized substantially as follows.

(1) An electronic ticket or an electronic coupon is stored in an IC card (or a portable telephone with a built-in IC chip, or the like).

(2) A user takes the IC card to a concert hall or a store.

(3) Contents of the IC card are read out by an information reader disposed at an admission gate of the concert hall or the store, and then the content of the electronic ticket or the electronic coupon is confirmed.

(4) This permits admission into the concert hall, discount sale of merchandise, or the like.

Thus, there is no need to use a printed paper ticket or paper coupon, thereby saving the trouble of issuing and mailing tickets or coupons.

However, the conventional method of utilizing an electronic ticket or coupon has the problem that information is not sufficiently utilized. For instance, since most IC cards have stored therein their owner's names or the like, when the information reader reads the contents of the IC card, information indicating who is entering a concert hall, the location of the concert hall, and the time of entry will be generated. Although this information is potentially useful for sales strategy and marketing, it is not actually used at all in the prior art method. This problem is also present in the use of an electronic coupon.

### SUMMARY OF THE INVENTION

Accordingly, it is an object of the invention to provide a system and computer program suitable for use in development of strategy by the company utilizing the foregoing information, which is otherwise wasted.

In one aspect, the present invention relates to a system for providing rights information comprising: right information managing means that includes memory means for storing a rights information group composed of a plurality of items of rights information which are provided to a user; customer management means for managing customer information about a customer including prediction information for predicting an action; and rights information receiving means for notifying a user of a right. wherein said rights information managing means receives the customer information from said customer management means, searches to locate, within said rights information group, rights information related to the predicted action based on the prediction information, and provides the related rights information to the rights information receiving means.

The store visit information may include user identification information for identifying a user visiting a store, and the rights information is provided to the user identified by the user identification information.

Preferably, the memory means includes a contact address for the user, and the rights information managing means informs the contact address that the rights information has been provided.

In another preferred embodiment, the rights receiving means is storage means for storing the rights information before it is transmitted to carrying means for carrying the rights information by the customer.

The customer information may include used-right information pertaining to rights used by the customer, with searching to locate rights information that is more usable than the used-right information.

The rights information provided to the rights receiving means may relate to rights usable in the store where acquired by the user or usable in a subsidiary of the store where acquired by the user.

Preferably, the rights information managing means provides the related right information before a presupposed action, on which the predicted action is based, is completed.

The customer information may include inducing information for inducing an action, and the searching process is for rights information related to the action to be induced, within the rights information group, based on the inducing information, the rights information managing means may provide the rights information before a presupposed action, on which the action to be induced is based, is completed.

### BRIEF DESCRIPTION OF THE DRAWINGS

FIG. 1 is a schematic view of an apparatus according to the present invention;

FIG. 2 is a diagram showing a membership file;

FIG. 3 is a diagram showing a folder management file;

FIG. 4 is a diagram showing a screen for confirming and downloading the folder;

FIG. 5 is a diagram showing memory content of an IC card;

FIG. 6 is a diagram showing store visit information;

FIG. 7 is a diagram showing a provided-right file;

FIG. 8 is a diagram showing transmitted rights information;

FIG. 9 is a diagram showing a screen for confirming and downloading a folder;

FIG. 10 is a diagram showing memory content of an IC card;

FIG. 11 is a diagram showing store visit information;

FIG. 12 is a diagram showing a provided-right file;

FIG. 13 is a diagram showing store visit information;

FIG. 14 is a diagram showing a provided-right file;

FIG. 15 is a diagram showing store visit information;

FIG. 16 is a diagram showing a provided-right file;

FIG. 17 is a diagram showing store visit information;

FIG. 18 is a diagram showing a provided-right file;

FIG. 19 is a diagram showing store visit information; and

FIG. 20 is a diagram showing a provided-right file.

### DESCRIPTION OF THE PREFERRED EMBODIMENTS

First Embodiment of the Invention

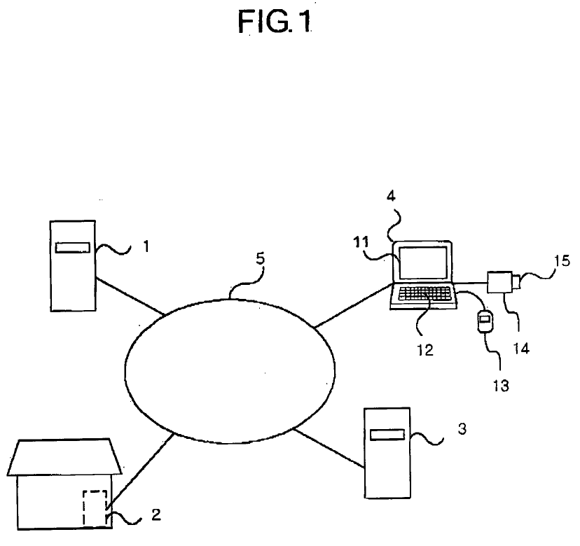

A first preferred embodiment of the invention will be explained with reference to the accompanying drawings wherein FIG. 1 is a schematic diagram showing hardware required for practice of the present invention as including a management server 1 (a server used by a company which manages rights information), an in-store terminal 2 (a computer disposed in a store, an event hall, or the like), a receiving server 3 (a server for receiving the rights information), and a PC 4 (a computer owned by a user).

The management server 1, the in-store terminal 2, the receiving server 3, and the PC 4 are connected to one another via Internet 5 (communicating means) so as to transmit and receive data therebetween.

The management server 1, the in-store terminal 2, the receiving server 3, and the PC 4 each have, built-in, a memory for storing data, a data transmitter for transmitting data, and a data receiver for receiving data, and transmit and receive data using them.

Each memory has a computer program required to carry out the invention and predetermined data stored therein. Each of the foregoing devices is given a command based on its associated computer program to process data in carrying out the invention.

The in-store terminal 2 has a built-in reader/writer for reading and writing data stored in the IC card.

The PC 4 includes a display monitor 11 for displaying data, a keyboard for data input 12, a mouse 13, and a reader/writer 14 for reading and writing data from and in the IC card. The IC card 15 may be inserted into the reader/writer for reading and writing the data.

The management server 1 functions as rights information managing means, the in-store terminal 2 as customer managing means, the receiving server 3 as rights receiving means, the IC card 15 as carrying means, the memory built into the managing server 1 as memory means, and the memory built into the receiving server 3 as yet-to-be-transmitted rights information storage means.

The present invention provides an electronic ticket and/or electronic coupon, or the like for customers who visit stores selling merchandise or visit event halls, thereby attracting a larger base of customers, improving the drawing power of an event, promoting the sale of merchandise, or the like.

Suppose, for example, Mr. Kazuo Mita, who lives in Tokyo, is a member of a service including provision of electronic tickets and coupons, by a company called Dream Company. The Dream Company deals in admission tickets for various events, coupons of various stores, or the like, and recently handles electronic tickets or coupons. An electronic ticket or coupon is a digitized version of the contents of an admission ticket or coupon which is stored and carried in a portable telephone or the like with an IC card or an IC chip built-in. In this manner the present invention provides a system by which a user carrying the ticket or coupon can enter an event hall or otherwise use the coupon. Mr. Mita owns an IC card 15 (see FIG. 1) for storing electronic tickets and/or electronic coupons.

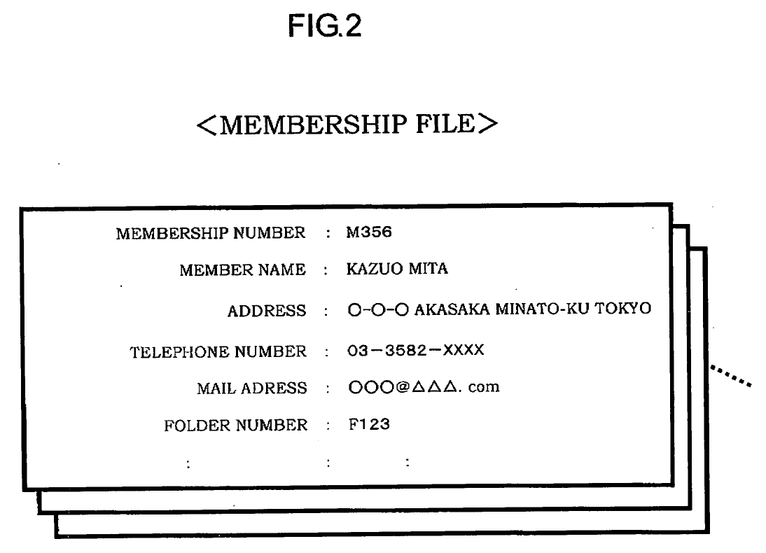

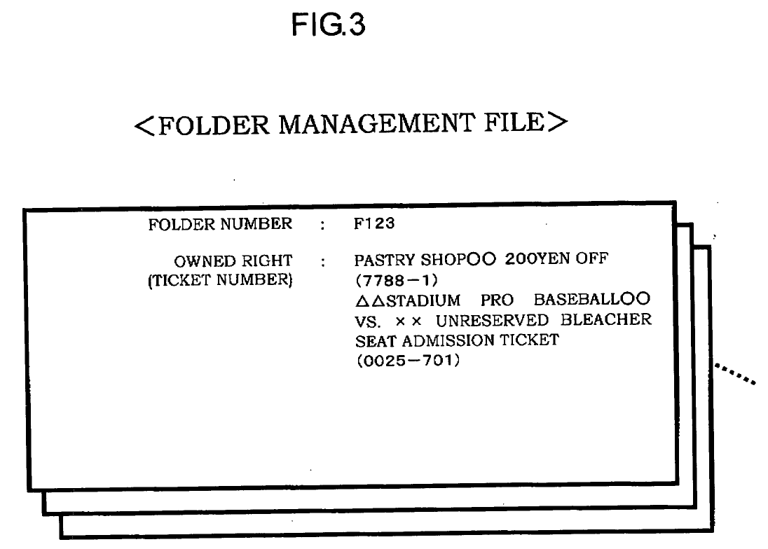

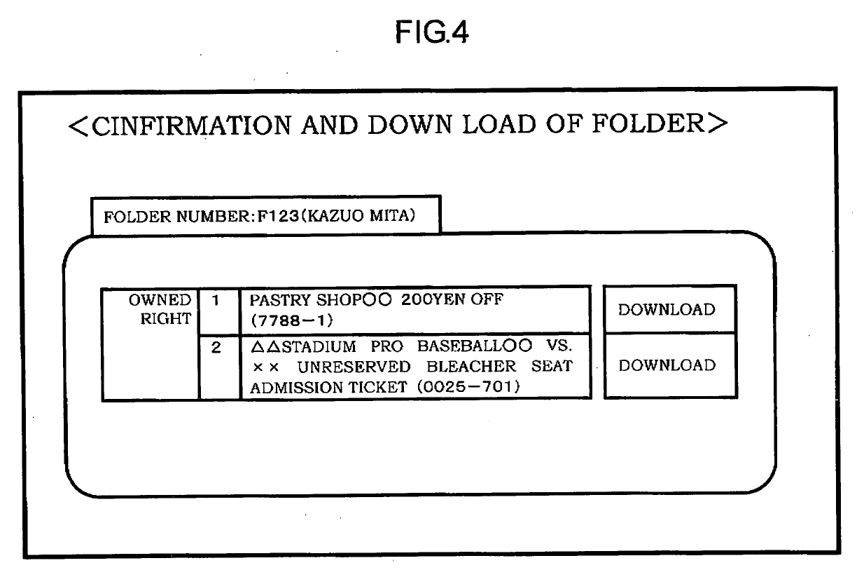

The management server 1, managed by the Dream Company, stores therein a membership file (see FIG. 2) composed of a plurality of membership records. The stored information for Mr. Mita includes “Membership Number: M356/Member Name: Kazuo Mita/Address: ∘-∘-∘ Akasaka Minato-ku Tokyo/Telephone Number: 03-3582-XXXX/Mail Address: ∘∘∘@ΔΔΔ.com/Folder Number: F123/. . . ” “Folder Number: F123” is a number for management of the electronic ticket and coupon owned by Mr. Mita. For example, when Mr. Mita owns the electronic coupon “Pastry Shop ∘∘ 200 yen off (7788-1)” and the electronic ticket “66 Δ Stadium, pro baseball ∘∘ vs. xx unreserved bleacher seat admission ticket (0025-701)”, “Folder Number: F123” is related (linked) to “Pastry Shop ∘∘ 200 yen off (7788-1)” and “ΔΔ Stadium, pro baseball ∘∘ vs. xx unreserved bleacher seat admission ticket (0025-701)”, which are stored in a folder management file stored in the receiving server 3 (see FIG. 3). When Mr. Mita uses the PC 4 to confirm his rights owned, the display monitor 11 of the PC 4 displays the owned rights in the manner shown in FIG. 4, i.e., with the ticket or coupon included in the folder F123. Thus, the owned tickets or the like are displayed in a folder format, thereby making it possible for a user (Mr. Mita) to easily confirm the content.

Execution of the method according to the present invention will is carried out as follows: <Transmission of Customer Information: STEP 1>→<Rights Information Search and Transmission: STEP 2>→<Rights Information Downloading: STEP 3>. These steps will be individually described below.

Transmission of Customer Information: STEP 1

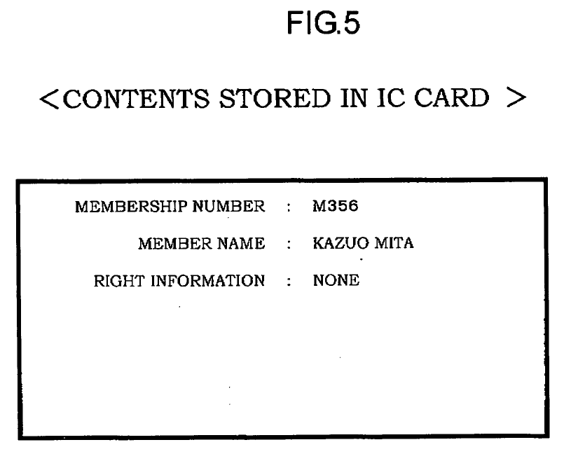

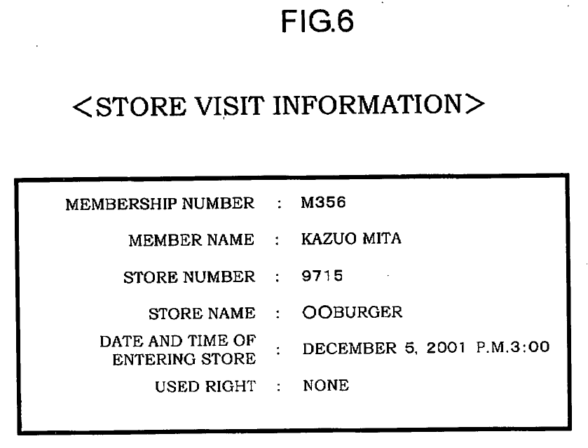

For example, Mr. Mita enters a hamburger shop named “∘∘ Burger” to have lunch. An in-store terminal 2 (see FIG. 1) is disposed in this ∘∘ Burger shop. When he inserts his IC card into an IC card slot of an IC card reader/writer of the in-store terminal 2, an electronic coupon, that will be usable the next time he comes to the shop, is entered into Mr. Mita's folder. It should be noted that Mr. Mita's IC card 15 pre-stores therein information as shown in FIG. 5. When Mr. Mita decides to purchase a hamburger, he passes the IC card 15 to a clerk. Then, the clerk inserts the IC card 15 into the IC card receiver. The in-store terminal 2 then reads the content stored in the IC card 15. Based on the read information, the in-store terminal compiles the store visit information shown in FIG. 6, for example, “Membership Number: M356/Member Name: Kazuo Mita/Store Number: 9715/Store Name: ∘∘ Burger/Date and Time of Entering Store: Dec. 5, 2001, p.m. 3:00/Used Right: None”. It transmits or sends this store visit information to the management server 1. The server 1 receives and stores the thus transmitted information. Within this information, “Membership Number: M356/Member Name: Kazuo Mita” are the contents that have been read from the IC card 15, and “Date and Time of Entering Store” is the information that has been read from a clock or the like built into the in-store terminal 2. The other information has been pre-stored in the in-store terminal 2. It should be noted that, in the preferred embodiment, the membership number functions as user specifying information, and the store number as store specifying information.

Rights Information Search and Transmission: STEP 2

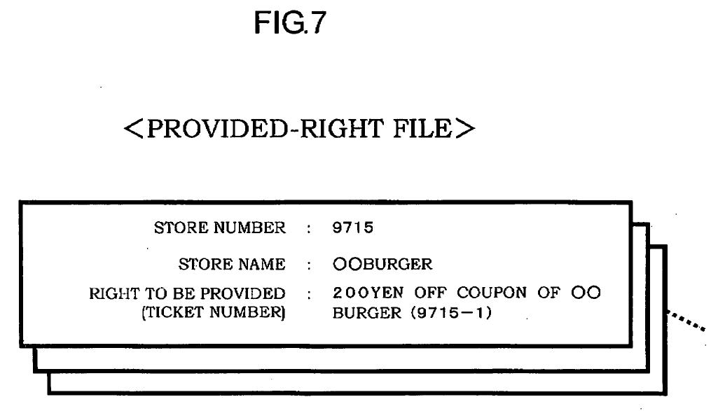

The management server 1 stores a provided-right file such as that shown in FIG. 7. This provided-right file is composed of a plurality of provided-right records, each of which relates (links) an electronic coupon or ticket provided by a store (or event hall) to the store number and the store name.

The management server 1 searches for or retrieves (carries out search processing) a provided-right file by designating the store visit information, namely, “Store Number: 9715” as a retrieval key. Accordingly, the provided-right record “Store Number: 9715/Store Name:∘∘ Burger/Right To be Provided (Ticket Number): 200 yen off coupon of ∘∘ Burger (9715-1)” is found and retrieved as shown in FIG. 7, thereby specifying a right to be provided. It should be noted that “200 yen off coupon (9715-1)” included in this provided-right records is an example of “right information”, and the provided-right file includes a plurality of items of rights information as a rights information group.

Then, the management server 1 searches through membership files by designating the store visit information, namely, “Membership Number: M356” as a retrieval key. Thus, Mr. Mita's membership record such as that shown in FIG. 2 is found, so that the management server 1 specifies Mr. Mita's “Folder Number: F123” and “Mail Address: ∘∘∘@ΔΔΔ.com”.

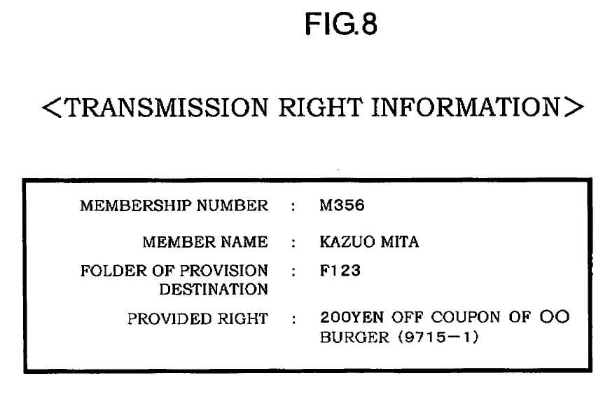

Next, the management server 1 generates transmission rights information, namely, “Membership Number: M356/Member Name: Kazuo Mita/Folder of Provision Destination: F123/Provided Right: 200 yen off coupon of ∘∘ Burger (9715-1)”, as shown in FIG. 8, based on the retrieved membership record, and the provided-right record, or the like, and then transmits it to the receiving server 3 which stores this rights information in its memory.

At the same time, the management server 1 sends a message, e.g., “A new electronic ticket or coupon has been added to your folder”, to Mr. Mita's e-mail address “∘∘∘ @ΔΔΔ.com”. It is noted that in this embodiment, the e-mail address functions as a contact address.

The receiving server 3, as described above, stores a folder management file such as that shown in FIG. 3. Such a folder management file is composed of a plurality of folder management records, each of which relates (links) the folder number to an owned right.

The receiving server 3 searches through the folder management file by designating the transmission right information “Folder of Provision Destination: F123” as a retrieval key. Thus, the folder management record “Folder Number: F123/Pastry Shop ∘∘ 200 yen off (7788-1), ΔΔ Stadium, pro baseball ∘∘ vs. xx unreserved bleacher seat admission ticket (0025-701)” is located and retrieved as shown in FIG. 3. Then, the receiving server 3 adds the record “200 yen off coupon of ∘∘ Burger (9715-1)” (which is an electronic coupon included in the transmission right information shown in FIG. 8) to the folder management record (see FIG. 3). That is, “200 yen off coupon of ∘∘ Burger (9715-1)” is related (linked) to “Folder Number: F123” to be stored. As a result, Mr. Mita's folder management record now includes the contents of “Folder Number: F123/Pastry Shop ∘∘ 200 yen off (7788-1), ΔΔ Stadium, pro baseball ∘∘ vs. xx unreserved bleacher seat admission ticket (0025-701), 200 yen off coupon of ∘∘ Burger (9715-1)”.

Rights Information Downloading: STEP 3

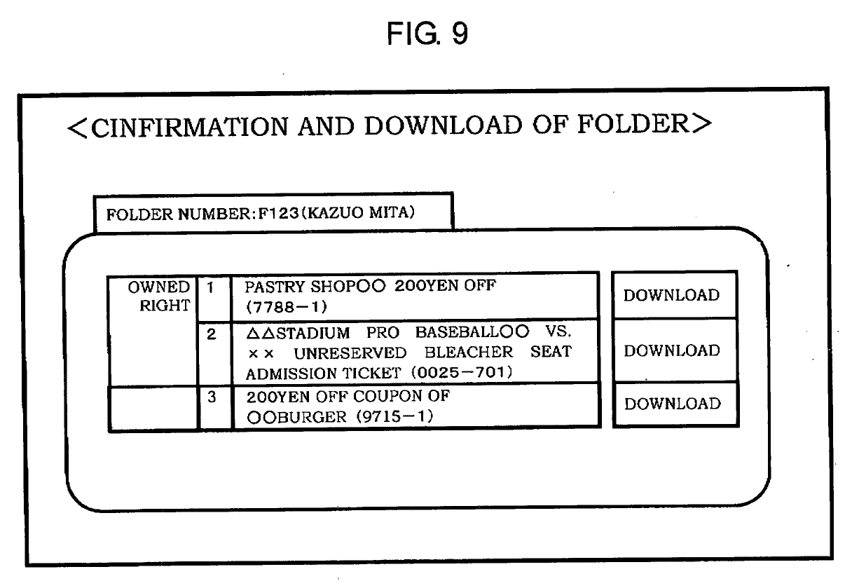

Suppose Mr. Mita returns home at night after having lunch at the ∘∘ Burger, and receives an e-mail using the PC 4. The received mail from the management server 1 includes a message that “A new electronic ticket or coupon has been provided”. Mr. Mita gains access to a web page operated by the Dream Company so as to confirm and download the provided electronic ticket and/or coupon. After the information “Folder Number: F123” or a predetermined password is input and sent, the content such as shown in FIG. 9 will be displayed on a display screen 11 of the PC 4.

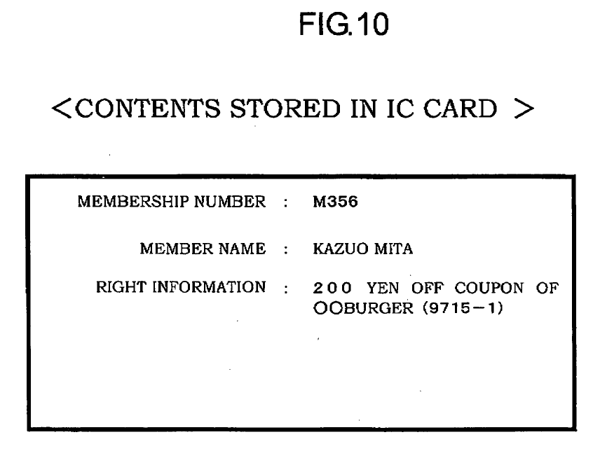

Because Mr. Mita is going to have a meal at the ∘∘ Burger next week, he touches a “download” window which is located next to the “200 yen off coupon of ∘∘ Burger (9715-1)” window. Thus, the PC 4 transmits a request for downloading information indicating “Ticket Number of Interest: 9715-1” to the receiving server 3. The server 3, responsive to receipt of the request, sends an electronic coupon for “200 yen off coupon of ∘∘ Burger (9715-1)” to the PC 4, while canceling the ticket transmitted from the folder management record. The PC 4 receiving the electronic coupon stores the received electronic coupon in the IC card 15 via the reader/writer 14 for the IC card. Accordingly, downloading of rights information is completed with the IC card 15 having stored therein the resultant content such as shown in FIG. 10.

After some days, Mr. Mita goes to the ∘∘ Burger, and passes the IC card 15 to a clerk or cashier in paying. When the clerk inserts the IC card 15 into the in-store terminal 2, the in-store terminal 2 reads the electronic coupon, and then subtracts 200 yen from the total price, while canceling the electronic coupon “200 yen off coupon of ∘∘ Burger (9715-1)” stored in the IC card 15. This allows Mr. Mita to get a discount of 200 yen off at the ∘∘ Burger.

The provision of the electronic coupon to the visiting customer (Mr. Mita) encourages the customer to visit the store (∘∘ Burger) again, leading to increased sales for the ∘∘ Burger and attracting a larger base of customers.

Second Embodiment of the Invention

Whereas in the foregoing first embodiment, provision of an electronic coupon for use in a store has been described, this second embodiment will serve to describe a case where an admission ticket (electronic ticket) for a movie, a concert, or the like is provided. It should be noted that the present embodiment is similar to the first embodiment in most part. That is, differences between this embodiment and the first embodiment are in the content of store visit information, and the content of the provided-right file. The remaining features of the present embodiment are substantially the same as those of the first embodiment. Only the features that are different will be described hereinafter.

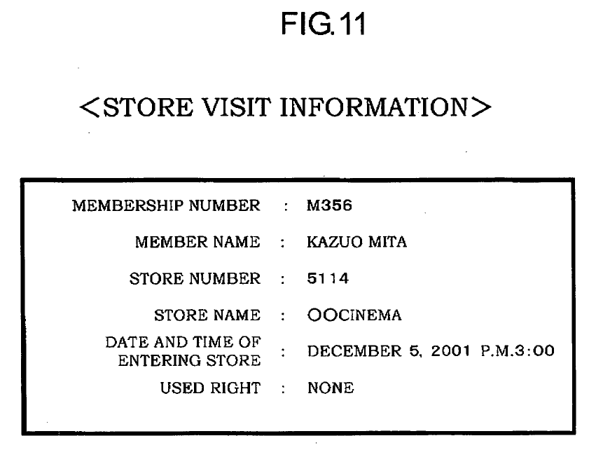

First, the content of store visit information will be explained. The visit information in this embodiment might have, by way of example, the following contents: “Membership Number: M356/Member Name: Kazuo Mita/Store Number: 5114/Store Name: ∘∘ Cinema/Date and Time of Entering Store: Dec. 5, 2001, p.m. 3:00/Used Right: None” as shown in FIG. 11. That is, when Mr. Mita goes to watch a movie at the ∘∘ Cinema, the in-store terminal 2 disposed at an entrance gate of the cinema reads out the contents of the IC card 15, and generates store visit information based on the read contents.

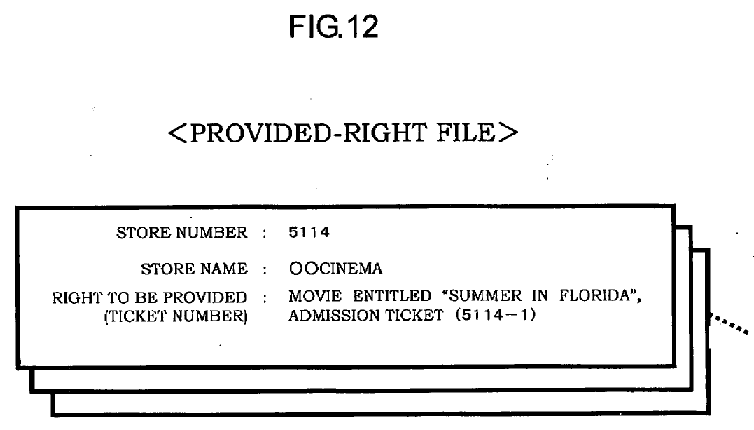

Now, the content of the provided-right file will be explained. The provided-right file has the following contents: “Store Number: 5114/Store Name: ∘∘ Cinema/Right To be Provided (Ticket Number): Movie entitled “Summer in Florida”, Admission Ticket (5114-1)” as shown in FIG. 12. That is, the right to be provided for Mr. Mita is an admission ticket for the movie entitled “Summer in Florida”, which will be screened at the ∘∘ Cinema next month.

This electronic ticket is processed in the same manner as in the first embodiment, sent to the receiving server 3, and then downloaded (stored) into Mr. Mita's IC card 15. This enables Mr. Mita to watch the “Summer in Florida” movie which will be screened at the ∘∘ Cinema next month, at a low price or at no charge. Thus, the present invention can handle not only coupons for stores selling merchandise, but also admission tickets for watching a movie, a concert, a sporting event, or the like. In short, the term “store” as used herein includes providing places in a broad sense, such as stores selling merchandise, stores giving services, a hall where an event is held, and the like.

Third Embodiment of the Invention

A third embodiment of the present invention illustrates the case where Mr. Mita brings the electronic coupon, which was provided in the first embodiment, to the ∘∘ Burger again. The present embodiment is similar to the first embodiment in most part. Differences between this embodiment and the first embodiment are in the contents of store visit information, in the contents of a provided-right file, and in the searching performed by the management server 1. The other features of the present embodiment are substantially the same as those of the first embodiment. Only the features which are different will be described hereinafter.

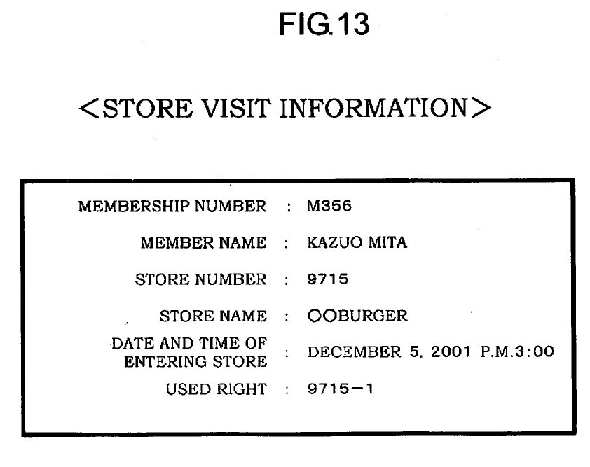

First, the content of the store visit information will be explained. The store visit information in this embodiment has the following contents: “Membership Number: M356/Member Name: Kazuo Mita/Store Number: 9715/Store Name: ∘∘ Burger/Date and Time of Entering Store: Dec. 5, 2001, p.m. 3:00/Used Right: 9715-1” as shown in FIG. 13. The difference between this embodiment and the first embodiment is that, while “Used Right” in the first embodiment is “none”, in this embodiment it is “9715-1”. The “Used Right” means the electronic coupon (or electronic ticket) that has been used by Mr. Mita at the ∘∘ Burger. That is, the in-store terminal 2 of the ∘∘ Burger reads the electronic coupon from the IC card 15 containing the content as shown in FIG. 10, and adds it when generating store visit information. It should be noted that in the present embodiment, the “Used Right: represents “used-right information.”

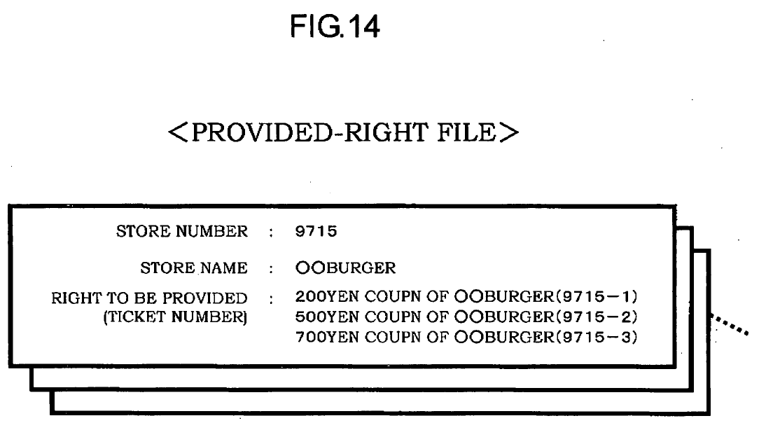

Next, the content of the provided-right file will be explained. The provided-right file has the following contents: “Store Number: 9715/Store Name: ∘∘ Burger/Right To be Provided (Ticket Number): 200 yen off coupon of ∘∘ Burger (9715-1), 500 yen off coupon of ∘∘ Burger (9715-2), 700 yen off coupon of ∘∘ Burger (9715-3)”, as shown in FIG. 14. The difference between this embodiment and the first embodiment is that in this embodiment a plurality (three) of rights are provided, which are stored in order of increasing value to a customer. In this embodiment, “500 yen off coupon of ∘∘ Burger (9715-2)”, and “700 yen off coupon of ∘∘ Burger (9715-3)” are more valuable rights information than the used right.

Now, the searching performed by the management server 1 will be explained below. This process is substantially the same as that of the first embodiment, but differs therefrom as follows. The used right of the store visit information is “9715-1”. Thus, the management server 1 searches for a ticket corresponding to “9715-2”, which is obtained by adding “1” to the foregoing “9715-1”, and sets this ticket as a provided right of the transmission right information. That is, the management server 1 generates the transmission right information “Membership Number: M356/Member Name: Kazuo Mita/Folder of Provision Destination: F123/Provided Right: 500 yen off coupon of ∘∘ Burger (9715-2)” (not shown), and transmits it to the receiving server 3. This coupon is processed as in the first embodiment, to be downloaded into Mr. Mita's IC card 15.

The customer is then provided with an electronic coupon that is more valuable than the used coupon, thereby enhancing the possibility that the customer will visit the store again and attracting a larger base of customers.

Fourth Embodiment of the Invention

While in the first embodiment, an electronic coupon usable at the ∘∘ Burger is provided to the customer who has visited the ∘∘ Burger, in this fourth embodiment an electronic coupon usable at a subsidiary of the ∘∘ Burger is issued. The present embodiment is similar to the first embodiment in most respects. The differences between this embodiment and the first embodiment are in the content of the store visit information, the content of a provided-right file, and the searching process performed by the management server 1. The other features of the present embodiment are substantially the same as those of the first embodiment. Accordingly, only points which are different will be described hereinafter.

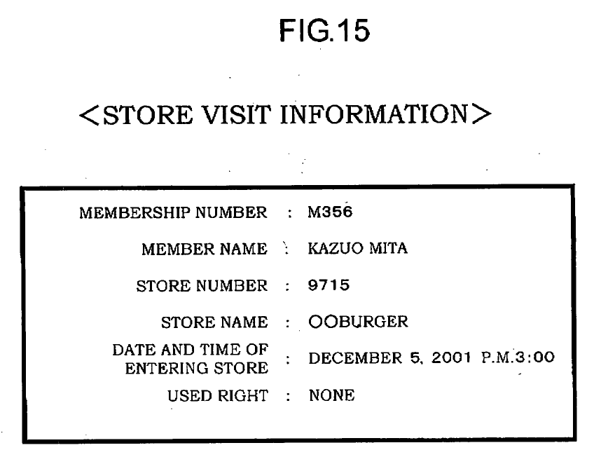

First, the content of the store visit information will be explained. The store visit information in this embodiment has the following contents: “Membership Number: M356/Member Name: Kazuo Mita/Store Number: 9715/Store Name: ∘∘ Burger/Date and Time of Entering Store: Dec. 5, 2001, p.m. 3:00/Used Right: None” as shown in FIG. 15. This information is the same as that of the first embodiment.

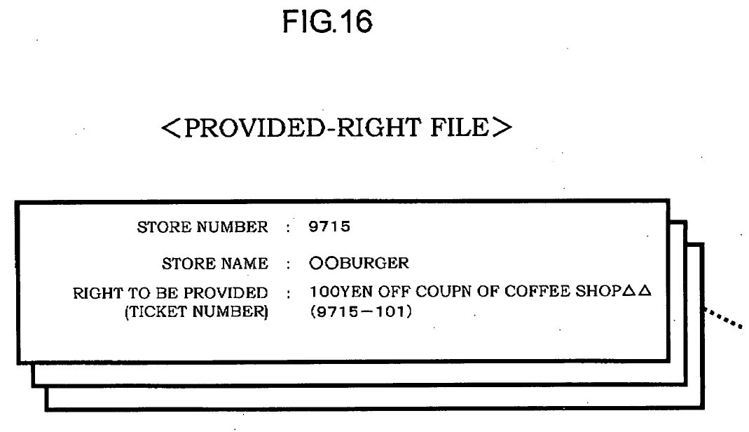

Next, the content of the provided-right file will be explained. The provided-right file has the following contents: “Store Number: 9715/Store Name: ∘∘ Burger/Right To be Provided (Ticket Number): 100 yen off coupon of Coffee Shop ΔΔ (9715-101)”, as shown in FIG. 16. Thus, this fourth embodiment differs from the first embodiment in that the right provided is not an electronic coupon usable at the ∘∘ Burger, but, rather, an electronic coupon usable at the Coffee Shop ΔΔ (which is a subsidiary of the ∘∘ Burger). It should be noted that in the present embodiment, “100 yen off coupon of Coffee Shop ΔΔ (9715-101)” is an example of the “rights information usable in its subsidiary store”.

Based on this store visit information, the same searching process as that of the first embodiment is executed and Mr. Mita obtains a coupon reading “100 yen off coupon of Coffee Shop ΔΔ (9715-101)”, enhancing the possibility that Mr. Mita will visit the Coffee Shop ΔΔ. This succeeds in attracting a larger base of customers to the subsidiary (one of group companies).

It should be noted that the “store” of the terminology “subsidiary store” is used in a broad sense to include, for example, not only stores selling merchandise and service, but also halls or the like where events are held, as described above.

Fifth Embodiment of the Invention

In the fifth embodiment, a customer's action is predicted based on customer information, and then an electronic coupon or the like conforming to the predicted action is provided. The fifth embodiment is similar to the first embodiment in most respects. Differences between this fifth embodiment and the first embodiment are in the content of the store visit information, in the content of a provided-right file, in the searching process performed by the management server 1, and in the process for transmission of rights information. Other aspects of the fifth embodiment are substantially the same as those of the first embodiment. Accordingly, only the different features will be described hereinafter. In the case of this fifth embodiment, downloading of the electronic coupon or the like is not performed by the PC 4, but is preferably performed by a portable compact computer, or a portable telephone with a built-in IC chip.

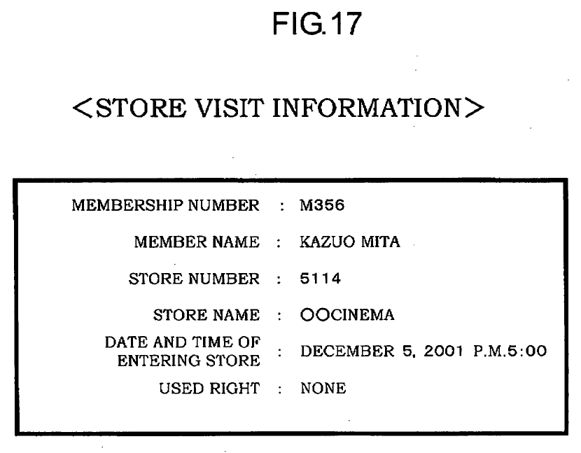

Included within the customer information, the store visit information in this fifth embodiment includes: “Membership Number: M356/Member Name: Kazuo Mita/Store Number: 5114/Store Name: ∘∘ Cinema/Date and Time of Entering Store: Dec. 5, 2001, p.m. 5:00/Used Right: None”, as shown in FIG. 17. This customer information is the same as that of the first embodiment. In the present embodiment, the date and time when the customer enters the store is the most important information and serves as the “prediction information.”

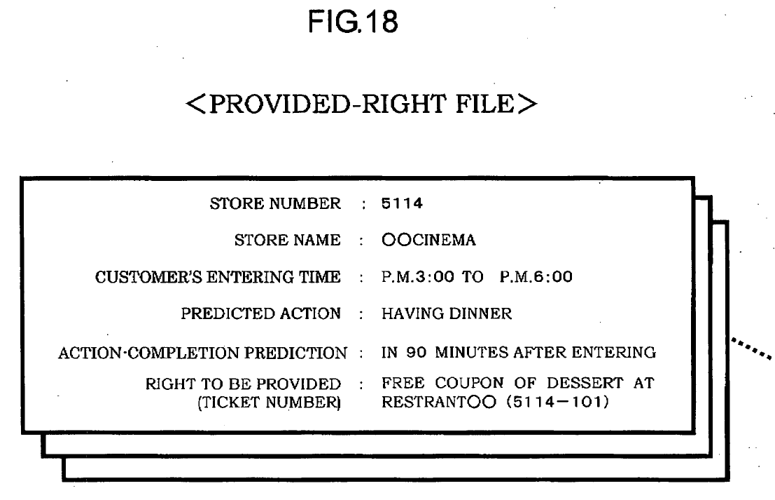

Next, the content of the provided-right file will be explained. The provided-right file has the following content: “Store Number: 5114/Store Name: ∘∘ Cinema/Customer's Entering Time: p.m. 3:00-6:00/Predicted Action: having dinner/Action-Completion Prediction: in 90 minutes after entering/Right To be Provided (Ticket Number): Free Coupon of Dessert at Restaurant ∘∘ (5114-101)”, as shown in FIG. 18. The differences from the first embodiment are the additionally provided items of data including the entering time, the predicted action, and the action-completion prediction, and that the nature of the right to be provided is based on the prediction “a customer who enters the cinema at p.m. 3:00 to p.m. 6:00 will have dinner after watching a movie”. In this preferred embodiment, the right to be provided is an electronic coupon usable at the Restaurant ∘∘ for dinner, e.g., “Coupon for Free Dessert at Restaurant 00 (5114-101)”. In this fifth embodiment, this “Coupon for Free Dessert at Restaurant ∘∘ (5114-101)” exemplifies what is referred to herein as “rights information related to the predicted action”. Further, in the embodiment, “a presupposed action” is exemplified by “watching a movie”, and “before the presupposed action is completed” is exemplified “by Dec. 5, 2001, p.m. 6:30,” which time is obtained by adding action-completion prediction time (90 minutes after entering) to Dec. 5, 2001, p.m. 5:00”. Of course, the invention is not so limited.

The searching process performed by the management server 1 is substantially the same as that of the first embodiment, but differs therefrom in that the management server 1 searches for a provided-right record of interest from the provided-right file by designating “Store Number: 5114” and “Entering Time: p.m. 5:00” as retrieval keys. As a result, the provided-right record such as that shown in FIG. 18 is located, and based on this record, transmission right information is generated.

Transmission processing of the transmission rights information for transmission to the receiving server 3, which is performed by the management server 1, is substantially the same as that of the first embodiment, but differs therefrom in that a customer's next action is predicted, and then an electronic coupon or the like, conforming to the predicted action, is provided. Therefore, if the electronic coupon to be provided does not reach a customer until the customer (Mr. Mita) leaves the movie theater (that is, until after the presupposed action is completed), it is meaningless. The timing of transmission of the transmission rights information is very important in the present embodiment.

The entering time in the customer information is “Dec. 5, 2001, p.m. 5:00”, and the time when Mr. Mita will leave the cinema is “action-completion prediction: in 90 minutes after entering” (at earliest 90 minutes). Thus, the management server 1 calculates the transmission timing to obtain the result “from p.m. 5:00 to p.m. 6:30”. During this time, the server 1 transmits the transmission right information to the receiving server 3. Accordingly, when Mr. Mita finishes watching the movie, the information “Coupon for Free Dessert at Restaurant ∘∘ (5114-101)” has been transmitted to Mr. Mita's folder. Therefore, when Mr. Mita, who is hungry after the movie, checks e-mail on his portable telephone or the like, a message that a new coupon has been provided is included in that e-mail, thereby enhancing the possibility that Mr. Mita will visit the Restaurant ∘∘. This enables provision of an electronic coupon or the like that conforms to a customer's action, resulting in an increase in opportunities for the customer to use the electronic coupon.

It should be noted that prediction of an action may be based on the user's sex, age bracket, the number of companions, or the like.

Sixth Embodiment of the Invention

In the foregoing fifth embodiment, a customer's action is predicted, and an electronic coupon or the like, conforming to the predicted action, is issued. On the other hand, this sixth embodiment issues an electronic coupon or the like to induce a customer's action. The present embodiment is similar to the first embodiment in most respects. Differences between this sixth embodiment and the first embodiment are in the content of store visit information, in the content of a provided-right file, and in the searching process performed by the management server 1. The other features of this sixth embodiment are substantially the same as those of the first embodiment. Only different features will be described hereinafter.

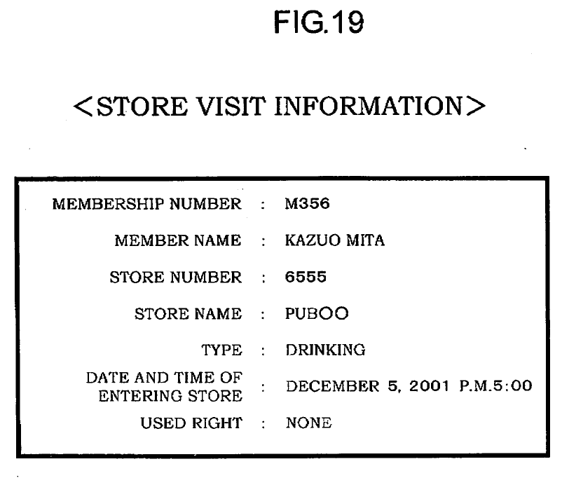

Within the customer information, the store visit information in this sixth embodiment has the following content: “Membership Number: M356/Member Name: Kazuo Mita/Store Number: 6555/Store Name: Pub ∘∘/Type: drinking/Date and Time of Entering Store: Dec. 5, 2001, p.m. 7:00/Used Right: None”, as shown in FIG. 19. This customer information differs from that of the first embodiment in that it additionally includes the item “Type: drinking”, an example of what is referred to herein as “inducing information.”

The provided-right file of this sixth embodiment has the following content: “Store Number: 6555/Store Name: Pub ∘∘/Type: drinking/Action To be Induced: inducing the customer to go to Beef Bowl (which is called “Gyudon” in Japanese) Restaurant ∘∘/Action-Completion Prediction: in 60 minutes after entering/Right To be Provided (Ticket Number): 100 yen off coupon of Beef Bowl Restaurant ∘∘ (5114-201)”. The features different from the first embodiment are that there are additionally provided data items including the type, the action to be induced, and the action-completion prediction, and that the content of the provided right is based on the objective of inducement: “although most people want to eat Chinese noodles after drinking alcohol, a coupon induces them to go to the Beef Bowl Restaurant”. It should be noted that in the present embodiment, “100 yen off coupon of Beef Bowl Restaurant ∘∘ (5114-201)” serves as “rights information related to the action to be induced”. Further, in this sixth embodiment, “presupposed induced action” is exemplified by “action of drinking and eating at the pub”, and “before the presupposed induced action is completed” is exemplified “by Dec. 5, 2001, p.m. 8:00, which time is obtained by adding an action-completion prediction time (60 minutes after entering) to Dec. 5, 2001, p.m. 7:00”.

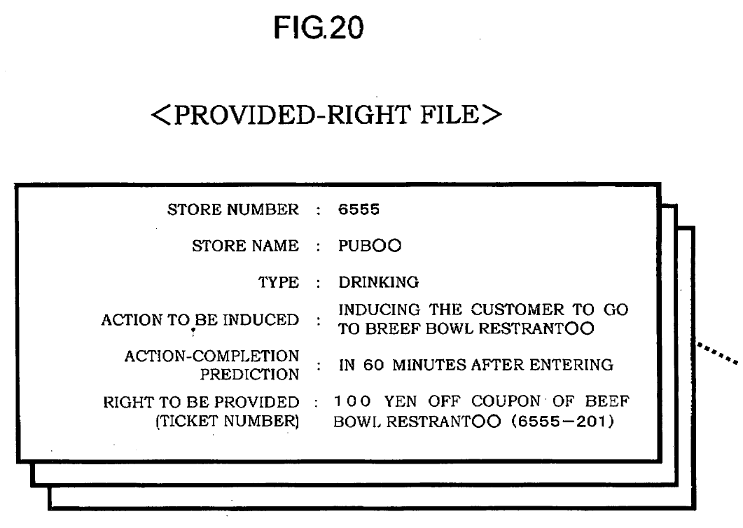

The searching process executed by the management server 1 is substantially the same as that of the first embodiment, but differs therefrom in that the type of customer information (action type) is “drinking”. Thus, the management server 1 searches for a provided-right record of interest from the provided-right file by designating “Store Number: 6555” and “Type: drinking” as retrieval keys. As a result, a provided-right record such as that shown in FIG. 20 is located.

The transmission of the transmission rights information to the receiving server 3, which is performed by the management server 1, is substantially the same as that of the first embodiment, but different therefrom in the following point.

In this sixth embodiment, the electronic coupon or the like is designed to induce a customer to act in a desired manner. Therefore, if the electronic coupon to be provided does not reach a customer until after the customer (Mr. Mita) leaves the pub (that is, after the presupposed action is completed), it is meaningless. The timing of the transmission right information is very important in the present embodiment.

The entry date and time in the customer information is exemplified by “Dec. 5, 2001, p.m. 7:00”, and the time when the customer will leave the pub is exemplified by “action-start prediction: in 60 minutes after entering” (at earliest 60 minutes). Thus, the management server 1 calculates the transmission timing to obtain the result “from p.m. 7:00 to p.m. 8:00”. During this time, the server 1 transmits the transmission right information to the receiving server 3. Accordingly, when Mr. Mita leaves the pub, the information “100 yen off coupon of Beef Bowl Restaurant ∘∘ (5114-201)” has been transmitted to Mr. Mita's folder. Therefore, when Mr. Mita, who wants to eat Chinese noodles after leaving the Pub ∘∘, looks at his portable telephone, he sees an e-mail saying “An electronic coupon has been transmitted to your folder.” Then, he downloads this new electronic coupon, i.e., “100 yen off coupon of Beef Bowl Restaurant ∘∘ (5114-201).” Thus, this coupon is stored in the IC chip of Mr. Mita's portable telephone, and its contents are displayed on a display screen of the phone. This enhances the possibility of Mr. Mita's going to Beef Bowl Restaurant ∘∘, rather than to a Chinese noodle restaurant. That is, the rate of utilization of the electronic coupon or the like provided by the Dream Company will be increased.

It should be noted that although in the foregoing, specific embodiments have been explained, the invention is not limited thereto. For example, the following are contemplated.

(1) Although an electronic ticket for a movie and an electronic coupon provided at a hamburger shop have been used for illustration in the foregoing embodiments, the electronic ticket or coupon according to the present invention may be one usable in any event hall, in any shop selling various merchandise or providing services, or the like.

(2) Although an electronic ticket or electronic coupon is sent to the yet-to-be-transmitted rights information storage means in the foregoing embodiments, the electronic ticket or electronic coupon may be directly sent to rights carrying means (means for carrying rights information: for example, a portable telephone or a compact computer with an IC chip built-in).

(3) The data content is not limited to that described in the foregoing embodiments, as any data will do as long as it has the same function.

(4) Hardware is not limited to that described in the foregoing embodiments, as any hardware will do as long as it has the same function. For example, the processing performed by the management server 1 and the processing performed by the receiving server 3 may be handled by only one server.

(5) The content and procedure of the processing are not limited to those explained in the foregoing embodiments. That is, any processing content and processing procedure will do as long as they have the same functions.

(6) The expression “accept information (data)” means “receive information (data)”. The expression “provide information (data)” means “transmit information (data)” but is not limited thereto.

(7) The term “customer” is intended to include all customers or visitors in a broad sense, for example, not only the case of a customer actually coming into a store, but also the case of the customer entering an event hall, inquiring of a store by a telephone, accessing a homepage, or the like.

(8) The data items of data presented in the foregoing embodiments are basically related (linked) to one another to be stored in the memory.

(9) The terminology “yet-to-be-transmitted rights information storage means for storing rights information before it is transmitted to the carrying means” has reference to the memory for storing (memorizing) the electronic ticket or the electronic coupon before it is downloaded via Internet into the portable telephone or the like with the IC card or IC chip built-in.

### INDUSTRIAL APPLICABILITY

The present invention has the following effects.

(1) The present invention provides customers visiting a store with electronic tickets or electronic coupons, thereby improving repeat customer rate (the probability of customers visiting the store again), and attracting a larger base of customers.

(2) Since the present invention provides electronic tickets or electronic coupons based on customer information, the electronic tickets or coupons provided conform to the customer's needs and actions. This provides effective utilization of information generated when the electronic ticket or coupon is surrendered.

(3) Issuance of an electronic ticket or electronic coupon usable in a store visited by a customer visits tends to increase repeat customer rate. Thus, each store attracts a larger base of customers.

(4) An electronic ticket or coupon newly provided is more useful than the previously used electronic ticket or coupon (used right), resulting in increased repeat customer rate.

(5) Provision of an electronic tickets or electronic coupons usable both in the store visited by the customer and in its subsidiaries (group of companies) attracts a larger base of customers to that group of companies.

(6) An action is predicted, and an electronic ticket or coupon that conforms to the predicted action is issued, thereby enhancing the rate of utilization of the electronic ticket or coupon.

(7) Issuance of an electronic ticket or coupon to induce a particular action by the customer can improve the pulling power of a store in which the electronic ticket or coupon is usable.

(8) If the electronic ticket or coupon is not provided until a predicted (presupposed) action or a presupposed induced action is completed, provision of the electronic ticket or coupon is meaningless, because it cannot be used. In the present invention, the electronic ticket or coupon is provided before a next action is started after customer information is received.

(9) Issuance of an electronic ticket or coupon is notified to the customer by an e-mail or the like, so that the customer knows that a new electronic ticket or the like has been added to his/her own folder.

(10) Since, in the present invention, the electronic ticket or coupon is transmitted to yet-to-be-transmitted right information storage means in the form of a customer folder, usage of the invention disclosed in Japanese Patent Application No. 2001-037078, entitled “A System for Transferring an Electronic Ticket, and a Computer Program for Achieving Same” can be further expanded.

1.-33. (canceled)

34. A system for providing rights information, comprising:
memory means for storing a plurality of its of rights information for issuance to a customer, correlated with predicted customer actions;
customer information management means for managing customer information;
rights information managing means for receiving the customer information, including prediction information for predicting a customer action, from said customer information management means, for searching the items of rights information stored in memory, based on the prediction information, to locate an item of rights information correlated with the predicted customer action and for transmitting the item of rights information located by the searching; and
rights receiving means for receiving the item of rights information transmitted by the rights information managing means.

35. The system for providing rights information according to claim 34, wherein the prediction information is based on a presupposed action taken by the customer and wherein said rights information managing means transmits the located rights information before the presupposed action is completed.

36. A system for providing rights information, comprising:
memory means for storing a plurality of items of rights information for issuance to a customer, correlated with different customer actions to be induced;
customer information management means for managing customer information;
rights information managing means for receiving the customer information, including inducing information for inducing a customer action, from said customer management means, for searching the items of rights information stored in memory, based on the inducing information, to locate an item of rights information correlated with the customer action to be induced, and for transmitting the item of rights information located by the search; and
right receiving means for receiving the item of rights information transmitted by the rights information managing means.

37. The system for providing rights information according to claim 36, wherein the inducing information is based on a presupposed action taken by the customer and wherein said rights information managing means transmits said rights information before the presupposed action for inducement is completed.

38. A system for providing right information, comprising:
memory means for storing a plurality of items of rights information for issuance to a customer;
customer information management means for managing customer information;
rights information managing means for receiving the customer information, including used-right information pertaining to rights used by the customer, from said customer information management means, for searching to locate an item of rights information that is more useful than the used-right information among the items of rights information stored in said memory means, based on the received customer information, and for transmitting the located item of rights information; and
rights receiving means for receiving the item of rights information transmitted by said rights information managing means.

39. A system for providing right information, comprising:
memory means for storing a plurality of items of rights information for issuance to a customer;
customer information management means for managing customer information;
yet-to-be-transmitted rights information storage means for storing located items of rights information to be transferred to a customer;
rights information managing means for receiving the customer information from the customer management means, for searching to locate a predetermined item of rights information from among the items of rights information stored in said memory means, based on the customer information, and for transmitting the located predetermined item of rights information to said yet-to-be-transmitted rights information storage means; and
carrying means for use by a customer to retrieve rights information from said yet-to-be-transmitted rights information storage means.

40. A system for providing right information, comprising:
memory means for storing a plurality of items of rights information for issuance to a customer and customer addresses;
customer information management means for managing customer information including a customer address;
rights information managing means for receiving customer information from said customer management means, for searching to locate a predetermined item of rights information stored in said memory means based on information included in the customer information, and for transmitting the located predetermined item of rights information to the customer address included in the customer information; and
receiving means, for receiving at the customer address, the located predetermined item of rights information for use by a customer.

41. A computer readable medium having, encoded thereon, a program for providing rights information, said program comprising:
storing in a memory a plurality of items of rights information for issuance to a customer, correlated with different predicted actions;
obtaining customer information from a terminal at a retail establishment or entertainment venue, the customer information including predicting information for predicting a customer action;
searching the memory to locate an item of rights information correlated with the predicted customer action;
transmitting the located item of rights information to a receiver; and
retrieving the located item of rights information from the receiver for use.

42. The computer readable medium of claim 41 wherein said program causes said transmitting before a presupposed action, on which the predicted action is based, is completed by the customer.

43. A computer readable medium having encoded thereon a program for providing rights information, said program comprising:
storing in a memory a plurality of items of rights information for issuance to a customer, correlated with different customer actions to be induced;
obtaining customer information from a terminal at a retail establishment or entertainment venue, the customer information including inducing information for a customer action to be induced;
searching the memory to locate an item of rights information correlated with the customer action to be induced;
transmitting the located item of rights information to a receiver; and
retrieving the located item of rights information from the receiver for use.

44. The computer readable medium according to claim 43 wherein said program causes said transmitting before a presupposed action for inducement, on which the action to be induced is based, is completed.

45. A computer readable medium having encoded thereon a program for providing rights information, said program comprising:
storing in a memory a plurality of items of rights information for issuance to a customer;
obtaining customer information from a terminal at a retail establishment or entertainment venue, the customer information including used-right information pertaining to rights used by the customer;
searching the memory to locate an item of rights information that is more useful than the used-right information;
transmitting the located item of rights information to a receiver; and
retrieving the located item of rights information from the receiver for use.

46. A computer readable medium having encoded thereon a program for providing rights information, said program comprising:
storing in a memory a plurality of items of rights information for issuance to a customer;
obtaining customer information from a terminal at a retail establishment or entertainment venue;
searching the memory to locate a predetermined item of rights information based on the customer information;
transmitting the located item of rights information to a storage unit; and
transferring the located item of rights information from the storage unit to a customer receiver for use by the customer.

47. A computer readable medium having encoded thereon a program for providing rights information, said program comprising:
storing in a memory a plurality of items of rights information for issuance to a customer;
obtaining customer information, including a customer address, from a terminal at a retail establishment or entertainment venue;
searching the memory to locate a predetermined item of rights information based on the customer information;
transmitting the located item of rights information to the customer address included in the customer information; and
receiving, at the customer address, the located predetermined item of rights information for use by the customer.

48. A method for providing rights information comprising:
storing in a memory a plurality of items of rights information for issuance to a customer, correlated with different predicted actions;
obtaining customer information from a terminal at a retail establishment or entertainment venue, the customer information including predicting information for predicting a customer action;
searching the memory to locate an item of rights information correlated with the predicted customer action;
transmitting the located item of rights information to a receiver; and
retrieving the located item of rights information from the receiver for use.

49. The method for providing rights information according to claim 48, wherein the located item of rights information is transmitted before a presupposed action, on which the predicted action is based, is completed.

50. A method for providing rights information comprising:
storing in a memory a plurality of items of rights information for issuance to a customer, correlated with different customer actions to be induced;
obtaining customer information from a terminal at a retail establishment or entertainment venue, the customer information including inducing information for a customer action to be induced;
searching the memory to locate an item of rights information correlated with the customer action to be induced;
transmitting the located item of rights information to a receiver; and
retrieving the located item of rights information from the receiver for use.

51. The method for providing rights information according to claim 50, wherein the located item of rights information is transmitted before a presupposed action, on which the action to be induced is based, is completed.

52. A method for providing rights information comprising:
storing in a memory a plurality of items of rights information for issuance to a customer;
obtaining customer information from a terminal at a retail establishment or entertainment venue, the customer information including used-right information pertaining to rights used by a customer;
searching the memory to locate an item of rights information that is more useful than the used-right information;
transmitting the located item of rights information to a receiver; and
retrieving the located item of rights information from the receiver for use.

53. A method for providing rights information comprising:
storing in a memory a plurality of items of rights information for issuance to a customer;
obtaining customer information from a terminal at a retail establishment or entertainment venue;
searching the memory to locate a predetermined item of rights information based on the customer information;
transmitting the located item of rights information to a storage unit; and
transferring the located item of rights information from the storage unit to a customer receiver for use by the customer.

54. A method for providing rights information comprising:
storing in a memory a plurality of items of rights information for issuance to a customer;
obtaining customer information, including a customer address, from a terminal at a retail establishment or entertainment venue;
searching the memory to locate an item of rights information based on the customer information;
transmitting the located item of rights information to the customer address included in the customer information; and
receiving, at the customer address, the located predetermined item of rights information for use by the customer.
